(19) United States
(12) Patent Application Publication
(10) Pub. No.: US 2014/0380101 A1
(43) Pub. Date: Dec. 25, 2014

(54) APPARATUS AND METHOD FOR DETECTING CONCURRENCY ERROR OF PARALLEL PROGRAM FOR MULTICORE

(71) Applicant: ELECTRONICS AND TELECOMMUNICATIONS RESEARCH INSTITUTE, Daejeon-city (KR)

(72) Inventor: Mi-Sun YU, Daejeon (KR)

(73) Assignee: ELECTRONICS AND TELECOMMUNICATIONS RESEARCH NSTITUTE, Daejeon-city (KR)

(21) Appl. No.: 14/285,958

(22) Filed: May 23, 2014

(30) Foreign Application Priority Data
Jun. 19, 2013 (KR) 10-2013-0070369

(51) Int. Cl. G06F 11/36

(52) U.S. Cl. CPC G06F 11/3636
USPC 714/38.1

(57) ABSTRACT

The apparatus for detecting concurrency errors of a parallel program for a multicore includes a source code matching module that adds a trace code and a dynamic thread manager class to an input source code based on interleaving information detected from the source code, splits a thread included in the source code to set an interleaving block and executes it, and when an error occurs in the executed interleaving block, the source code matching modules stores log information output from the trace code and information of interleaving block, and stores error information based on the information.

### CROSS REFERENCE TO RELATED APPLICATION

This application claims the benefit of Korean Patent Application No. 10-2013-0070369, filed on Jun. 19, 2013, which is hereby incorporated by reference in its entirety into this application.

### BACKGROUND OF THE INVENTION

1. Field of the Invention

The present disclosure relates to an apparatus and method for detecting a concurrency error of a parallel program for a multicore and, more particularly, to an apparatus and method for detecting a concurrency error of a parallel program for a multicore capable of detecting errors occurring when threads are simultaneously executed in a parallel program operated with multi-thread.

2. Description of the Related Art

Recent advances in technologies have rapidly promoted prevalence of desktop computers equipped with a multicore processor. A multicore processor includes a plurality of cores, so individual cores may operate at a low frequency and power consumption of a single core may be distributed to several cores. A multicore processor supports a fast operation and exhibits its performance in operations such as video encoding, photoshop work, or high-end games, relative to a single core processor.

With the prevalence of desktop computers equipped with a multicore processor increasing, importance of a multi-thread program capable of making the most of performance of a multicore is also growing.

A multi-thread program, however, involves concurrency errors occurring when a plurality of threads are simultaneously executed. Concurrency errors occur due to inter-thread non-deterministic interleaving, and since it is difficult to find a situation initiating occurrence of an error and a cause thereof, a multi-thread program is hard to be created.

Three typical examples of concurrency errors are a data race, an atomicity violation, and ordering violation. These errors lead to failure of a program operation or an error of a result value.

Typical solutions to concurrency errors include a method of finding an error pattern by analyzing a source code, a method of finding a situation initiating occurrence of an error by analyzing a log which has dynamically executed a program, a method of replaying an error situation of a program to help error detection, and the like. For example, U.S. Patent Application Publication No. 2012/0144372 (Entitled “SYSTEM AND METHOD FOR FINDING CONCURRENCY ERRORS”) discloses a method for detecting concurrency errors by using a log file generated when a multithread program is executed.

Among the solutions, the method of analyzing a source code is disadvantageously inaccurate, and the replay method is advantageous as long as a user finds an error situation. The method of dynamically executing a program has shortcomings in that it takes a long time although it accurately finds an error situation.

Other existing dynamic execution methods are based on an assumption that if statements are executed several times without accurately considering inter-thread interleaving, statements performed by threads will be executed in different orders. Thus, these methods cannot find every situation causing an error, as well as being dependent upon a stochastic method. In addition, since logs (or a portion of logs) executed by a program are provided to users, potentially excessively increasing information to be analyzed by users.

### SUMMARY OF THE INVENTION

The present disclosure provides an apparatus and method for detecting concurrency errors of a parallel program for a multicore capable of outputting log information related to a shared variable access procedure associated with a cause of errors, in particular, concurrency errors causing failure of a program and a position in a source code, upon receiving a compiled source code and an input value for executing a program, as an input.

The present disclosure also provides an apparatus and method for detecting concurrency errors of a parallel program for a multicore capable of detecting a cause of concurrency errors in consideration of inter-thread interleaving.

In an aspect, an apparatus for detecting concurrency errors of a parallel program for a multicore may include: an information extracting module configured to detect interleaving information from an input source code; a trace code adding module configured to add a trace code and a dynamic thread manager class to the source code based on the interleaving information detected by the information extracting module; an interleaving setting module configured to split a thread included in the source code having the trace code and the dynamic thread manager class added thereto by the trace code adding module to set an interleaving block; an executing module configured to execute the interleaving block set by the interleaving setting module; a trace information collecting module configured to, when an error occurs in the interleaving block executed by the executing module, store log information output from the trace code added to the interleaving block and information of the interleaving information; and a source code matching module configured to store error information based on the log information and the source code stored in the trace information collecting module.

The information extracting module may detect interleaving information including a shared variable, a shared thread class, a shared variable read statement and write statement, a user added assert statement, and a synchronized block.

The trace code adding module may add the trace code before and after the shared variable read statement and write statement and before and after the synchronized block including a shared variable included in the interleaving information.

The trace code may output log information including a time stamp, an ID of a thread being executed, a name of a class to which an executed code belongs, a name of a method to which an executed code belongs, an ID of a synchronized block, a name of an accessed variable, and a variable access mode.

The trace code adding module may add a dynamic thread manager class including a method of registering a set thread, a method of deleting set thread information, a method of stopping a set thread, a method of requesting resume of an operation of a thread other than a set thread, to the source code.

The trace code adding module may add a method of registering a thread set in the beginning of a run function of threads included in the source code and add a method of deleting thread information set in the end of the run function.

The interleaving setting module may set an interleaving block having a maximum level including all of run functions of a thread, and split the set interleaving block based on execution results of the set interleaving block having a maximum level to reset a plurality of interleaving blocks.

When an error does not occur in executing the set interleaving block, the interleaving setting module may reset the interleaving block into a plurality of interleaving blocks having a level equal to or higher than a minimum level, and may set an interleaving block including a single shared variable read statement or user added assert statement as an interleaving block having the minimum level.

The interleaving setting module may add a code for changing a different thread using a shared variable of an interleaving block in the beginning of the interleaving block into a standby state, and add a code for re-executing a thread changed to a standby state in the end of the interleaving block.

The source code matching module may store error information including an error occurrence situation and position.

In another aspect, a method for detecting concurrency errors of a parallel program for a multicore may include: detecting, by an information extracting module, interleaving information from an input source code; adding, by a trace code adding module, a trace code and a dynamic thread manager class to the source code based on interleaving information detected in the detecting operation; splitting, by an interleaving setting module, a thread included in the source code having the trace code and the dynamic thread manager class added in the adding operation to set an interleaving block; executing, by an executing module, the interleaving block set in the setting operation; when an error occurs in the interleaving block executed in the executing operation, storing, by a trace information collecting module, log information output from the trace code added to the interleaving block and information of the interleaving block; and storing, by a source code matching module, error information based on the log information stored in the operation of storing the log information and the information of the interleaving block.

In the operation of detecting the blocking information, interleaving information including a shared variable, a shared thread class, a shared variable read statement and write statement, a user added assert statement, and a synchronized block may be detected by the information extracting module.

In the operation of adding a trace code and a dynamic thread manager class, the trace code may be added before and after the shared variable read statement and write statement and before and after the synchronized block including a shared variable included in the interleaving information by the trace code adding module.

The trace code may output log information including a time stamp, an ID of a thread being executed, a name of a class to which an executed code belongs, a name of a method to which an executed code belongs, an ID of a synchronized block, a name of an accessed variable, and a variable access mode.

In the operation of adding a trace code and a dynamic thread manager class, a dynamic thread manager class including a method of registering a set thread, a method of deleting set thread information, a method of stopping a set thread, a method of requesting resume of an operation of a thread other than a set thread, may be added to the source code by the trace code adding module.

In the operation of adding a trace code and a dynamic thread manager class, a method of registering a thread set in the beginning of a run function of threads included in the source code may be added and a method of deleting thread information set in the end of the run function may be added by the trace code adding module.

In the operation of setting an interleaving block, an interleaving block having a maximum level including all of run functions of a thread may be set and split based on execution results of the set interleaving block having a maximum level to reset a plurality of interleaving blocks by the interleaving setting module.

in the operation of setting an interleaving block, when an error does not occur in executing the set interleaving block, the interleaving block may be reset into a plurality of interleaving blocks having a level equal to or higher than a minimum level, and an interleaving block including a single shared variable read statement or user added assert statement may be set as an interleaving block having the minimum level by the interleaving setting module.

In the operation of setting an interleaving block, a code for changing a different thread using a shared variable of an interleaving block may be added in the beginning of the interleaving block into a standby state, and a code for re-executing a thread changed to a standby state may be added in the end of the interleaving block by the interleaving setting module.

In the operation of storing error information, error information including an error occurrence situation and position may be stored by the source code matching module.

In the case of the apparatus and method for detecting concurrency errors of a parallel program for a multicore according to embodiments of the present disclosure, concurrency errors may be more accurately detected by directly controlling thread interleaving, rather than being executed in a computer itself.

In the case of the apparatus and method for detecting concurrency errors of a parallel program for a multicore according to embodiments of the present disclosure, since concurrency errors are detected by adjusting a size of interleaved thread command statement block by stages, accuracy and executed time of concurrency error detection may be adjusted.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating an apparatus for detecting concurrency errors of a parallel program for a multicore according to an exemplary embodiment of the present disclosure.

FIGS. 2 through 4 are views illustrating a trace code adding module of FIG. 1.

FIG. 5 is a flow chart illustrating a method for detecting concurrency errors of a parallel program for a multicore according to an exemplary embodiment of the present disclosure.

FIGS. 6 through 10 are views illustrating the method for detecting concurrency errors of a parallel program for a multicore according to an exemplary embodiment of the to present disclosure.

### DESCRIPTION OF THE PREFERRED EMBODIMENTS

Embodiments will be described in detail with reference to the accompanying drawings such that they can be easily practiced by those skilled in the art to which the present disclosure pertains. In the drawings, like or similar reference numerals are used for like or similar parts, although they are illustrated in different drawings. Also, in describing the present disclosure, if a detailed explanation for a related known function or construction is considered to unnecessarily divert the gist of the present disclosure, such explanation will be omitted but would be understood by those skilled in the art.

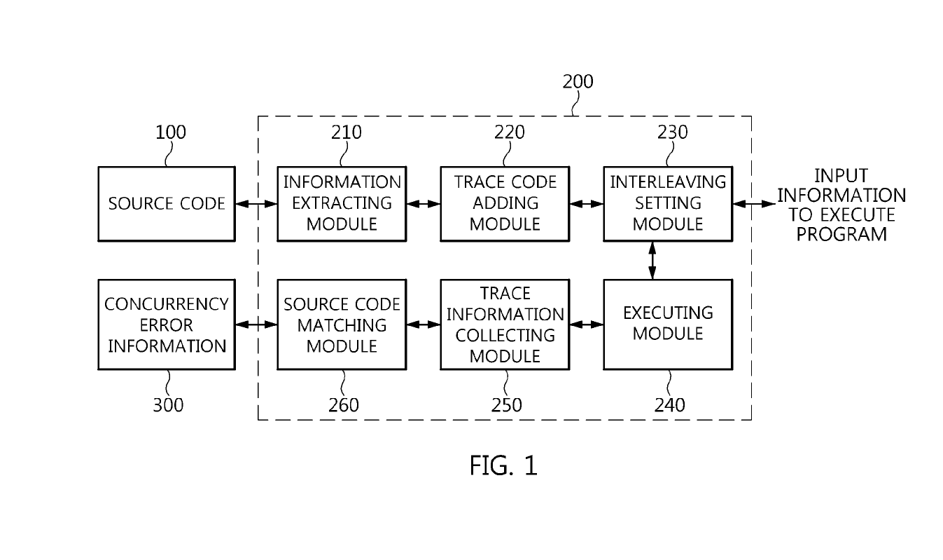

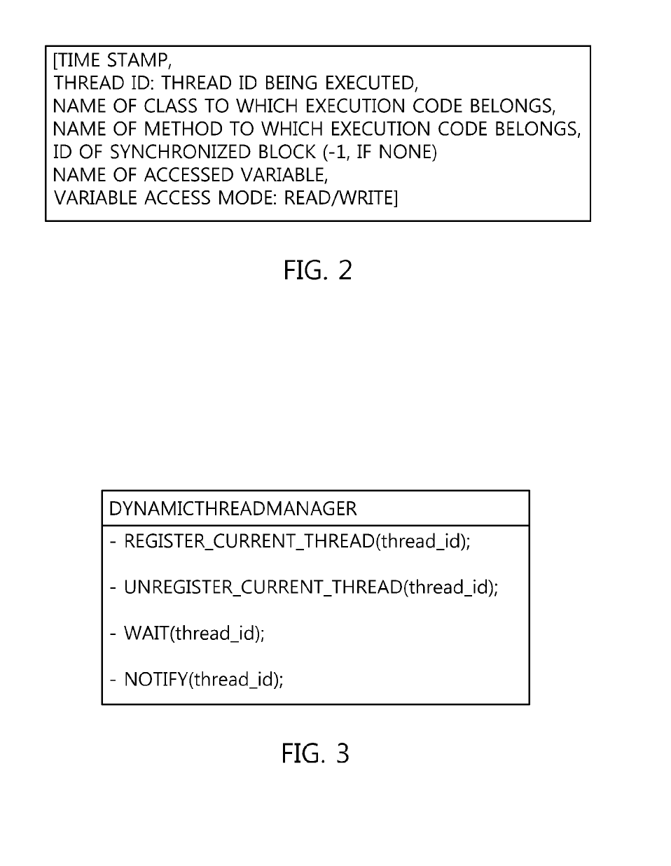

Hereinafter, an apparatus for detecting a concurrency error of a parallel program for a multicore will be described in detail with reference to the accompanying drawings. FIG. 1 is a block diagram illustrating an apparatus for detecting concurrency errors of a parallel program for a multicore according to an exemplary embodiment of the present disclosure, and FIGS. 2 through 4 are views illustrating a trace code adding module of FIG. 1.

As illustrated in FIG. 1, an apparatus 200 for detecting concurrency errors of a parallel program for a multicore includes an information extracting module 210, a trace code adding module 220, an interleaving setting module 230, an executing module 240, a trace information collecting module 250, and a source code matching module 260.

The information extracting module 210 detects interleaving information from a source code 100. Here, the information extracting module 210 detects interleaving information including a shared variable, a shared thread class, a read statement and a write statement using a shared variable, a user added assert statement, and a synchronized block.

The information extracting module 210 detects a shared variable and a shared thread class from the input source code 100. Namely, the information extracting module 210 detects a shared variable list including shared variables accessed by a thread. The information extracting module 210 detects a thread class including a code accessing shared variables included in the shared variable list.

The information extracting module 210 detects a read statement and a write statement using a shared variable. Namely, occurrence of an error of a program (namely, program failure) due to shared variable access is externally expressed as occurrence of exception, or the like, with respect to a read statement of a shared variable. Such an error is caused by a write statement of a shared variable, so order of performing a read statement/write statement of a shared variable is important information to be provided to users. Thus, in order to allow the trace code adding module 220 (to be described) to insert a log related to performing order in executing a program, the information extracting module 210 detects positions of a read statement and a write statement with respect to a variable (namely, a shared variable) shared between or among threads within a program and store the detected positions.

The information extracting module 210 detects a user added assert statement. Namely, when conditions desired by a variable value are not satisfied while a program is being executed, the information extracting module 210 detects an assert statement causing an exception. In this case, the information extracting module 210 equally treats the detected assert statement like a read statement of a shared variable.

The information extracting module 210 detects a synchronized block. Namely, the information extracting module 210 detects a synchronized block executed without interleaving from within a plurality of threads included in a program.

The trace code adding module 220 adds a trace code and a dynamic thread manager class to the source code 100 based on interleaving information detected by the information extracting module 210.

The trace code adding module 220 adds a trace code to the source code 100 based on the information detected by the information extracting module 210. Namely, the trace code adding module 220 adds a trace code outputting log information before and after the shared variable read statement and write statement and before and after the synchronized block including a shared variable. Here, as illustrated in FIG. 2, the added trace code outputs log information including a time stamp, a thread ID being executed, a name of class to which an execution code belongs, a name of a method to which an execution code belongs, an ID of a synchronized block, a name of accessing variable, a variable access mode (read/write).

The trace code adding module 220 adds a dynamic thread manager class managing information to a thread being operated in a program. In this case, as illustrated in FIG. 3, the dynamic thread manager class provides REGISTER_CURRENT_THREAD method that registers a set thread (namely, thread corresponding to thread_id), UNREGISTER_CURRENT_THREAD method that deletes information when the set thread (namely, thread corresponding to thread_id) is terminated, WAIT method that stops the set thread (namely, thread corresponding to thread_id), and NOTIFY method that requests threads other than the set thread (namely, thread corresponding to thread_id) to resume a thread operation.

The trace code adding module 220 inserts a code (i.e., REGISTER_CURRENT_THREAD method) of registering a thread ID to the dynamic thread manager class in the beginning of a run function of a thread. The trace code adding module 220 inserts a code (i.e., UNREGISTER_CURRENT_THREAD method) of removing a thread ID from the dynamic thread manager class in the end of the run function.

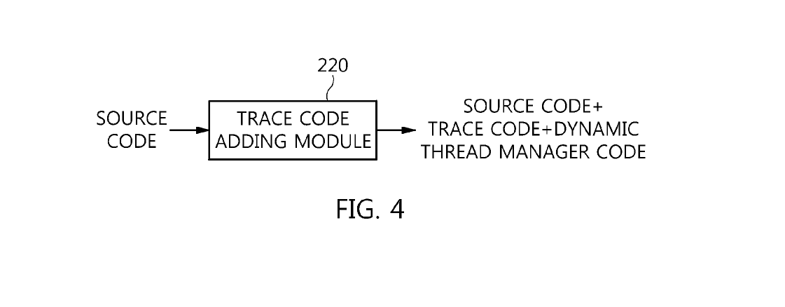

The trace code adding module 220 outputs data including a trace code and a dynamic thread manager code (namely, at least one of four methods included in the dynamic thread manager class) through addition of a trace code and dynamic thread manager class. Namely, as illustrated in FIG. 4, the trace code adding module 220 outputs data obtained by adding the trace code and the dynamic thread manager code to the source code 100.

When information for program execution is input, the interleaving setting module 230 splits a thread included in the source code 100 into interleaving blocks. Namely, concurrency errors of a multithread program occurs as several threads accesses a shared variable in non-predicted order. Thus, when interleaving order of shared variable access statements executed by different threads is directly determined and executed, a case in which an error occurs may be found.

In existing methods (e.g., Conseq), different interleaving is induced by adding a certain delay between statements or repeatedly executing statements, but these methods are highly unlikely to find out a case in which an actual error occurs. However, number of cases that interleaving occurs between threads is exponentially increased as the number of threads is increased, so it is substantially impossible to calculate and execute every possible case from the beginning.

Thus, the interleaving setting module 230 splits a thread code into atomic large block units and sets them as interleaving blocks. The interleaving setting module 230 sets interleaving blocks, while reducing a size thereof based on execution results of set interleaving blocks (namely, according to whether an error has occurred according to execution of interleaving blocks) set by the executing module. Here, as for the interleaving blocks, a block having the entirety of a single thread code (namely, run function) is the largest unit (i.e., a maximum level), and a blocking including a read access statement with respect to a single shared variable and an assert statement is the smallest unit (i.e., a minimum level). Here, when no error has occurred according to the execution results of an interleaving block, the interleaving setting module 230 splits the corresponding interleaving block into a plurality of interleaving blocks.

The interleaving setting module 230 sets interleaving blocks in order to allow only a single particular code block to be executed at a time among threads simultaneously accessing a shared variable. Thus, if a thread using that uses a shared variable together with a current thread is being executed before executing of the interleaving block starts, the interleaving setting module 230 adds a code for making the corresponding thread wait, and when there is a thread that waits at the end of the interleaving block, the interleaving setting module 230 adds a code for allowing the corresponding thread to be re-executed. Here, in case of Java, an execution state of a thread accessing a shared variable together may be obtained from a thread manager, and by adding wait( ) and notify( ) inter-process mechanisms provided by Java, standby and re-execution of a thread are set when an interleaving block is executed.

As threads are increased and codes accessing a shared variable are increased, the number of interleaving blocks is also increased, and thus, number of cases to be executed is increased accordingly. Thus, the interleaving setting module 230 may set to split an interleaving block up to a predetermined level in size to minimize an execution time of a test, although accuracy is slightly lowered.

The executing module 240 executes the interleaving block set in the interleaving setting module 230. Namely, the executing module 240 executes an interleaving block set by the interleaving setting module 230, and when an error occurs, the executing module 240 transmits the same to the interleaving setting module 230 and the trace information collecting module 250. In this case, the executing module 240 transmits log information output from a trace code added to the interleaving block to the interleaving setting module 230 and the trace information collecting module 250.

The trace information collecting module 250 stores the log information and the information of the interleaving block received from the execution module 240 in the form of a file.

The source code matching module 260 stores concurrency error information 300 including an error occurrence situation and position based on the file generated by the trace information collecting module 250, as a file. Namely, the source code matching module 260 may read the file generated by the trace information collecting module 250 and stores information regarding at which portion (line number) of the source code 100 each error has occurred or at which interleaving situation an error has occurred, as a file. The line number of the source code 100 may be found by using a class name, a function name, and a variable name included in the log information.

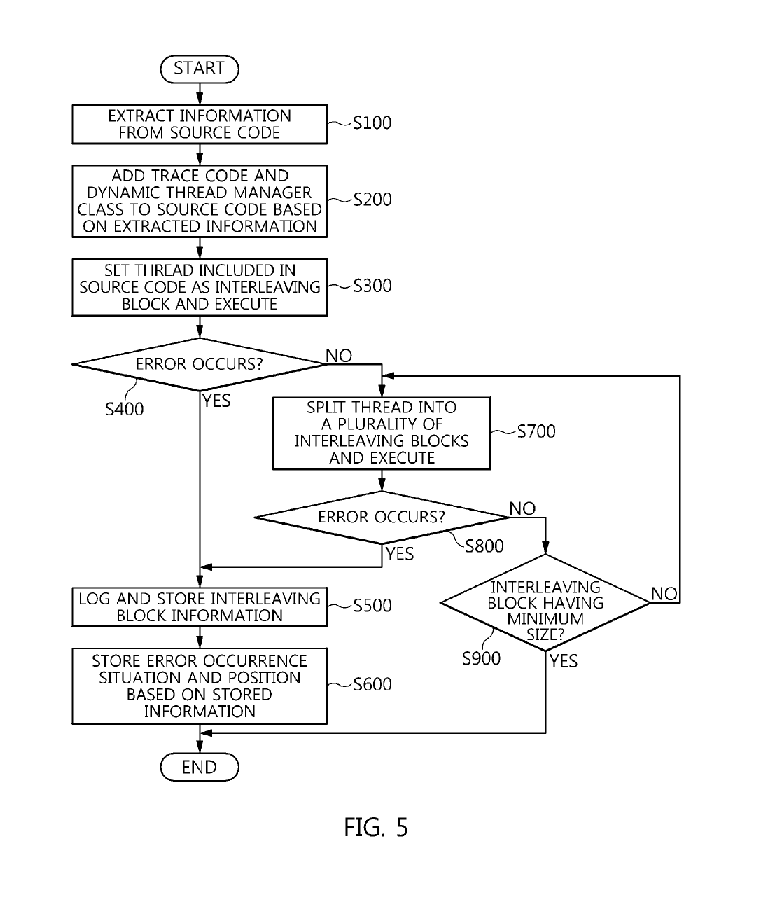

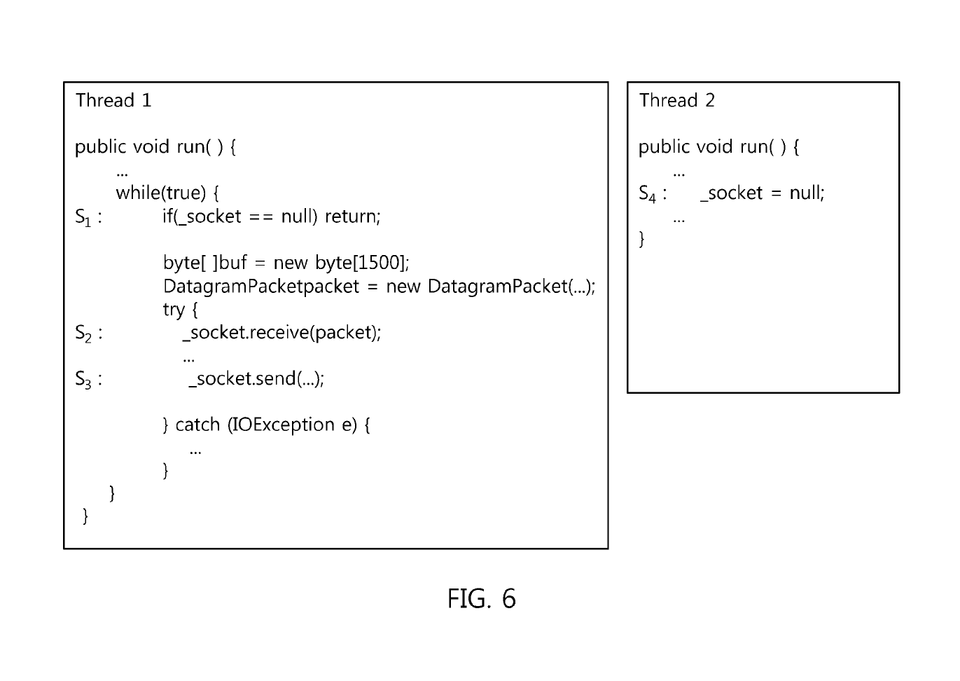

Hereinafter, a method for detecting a concurrency error of a parallel program for a multicore will be described in detail with reference to the accompanying drawings. FIG. 5 is a flow chart illustrating a method for detecting concurrency errors of a parallel program for a multicore according to an exemplary embodiment of the present disclosure, and FIGS. 6 through 10 are views illustrating the method for detecting concurrency errors of a parallel program for a multicore according to an exemplary embodiment of the present disclosure.

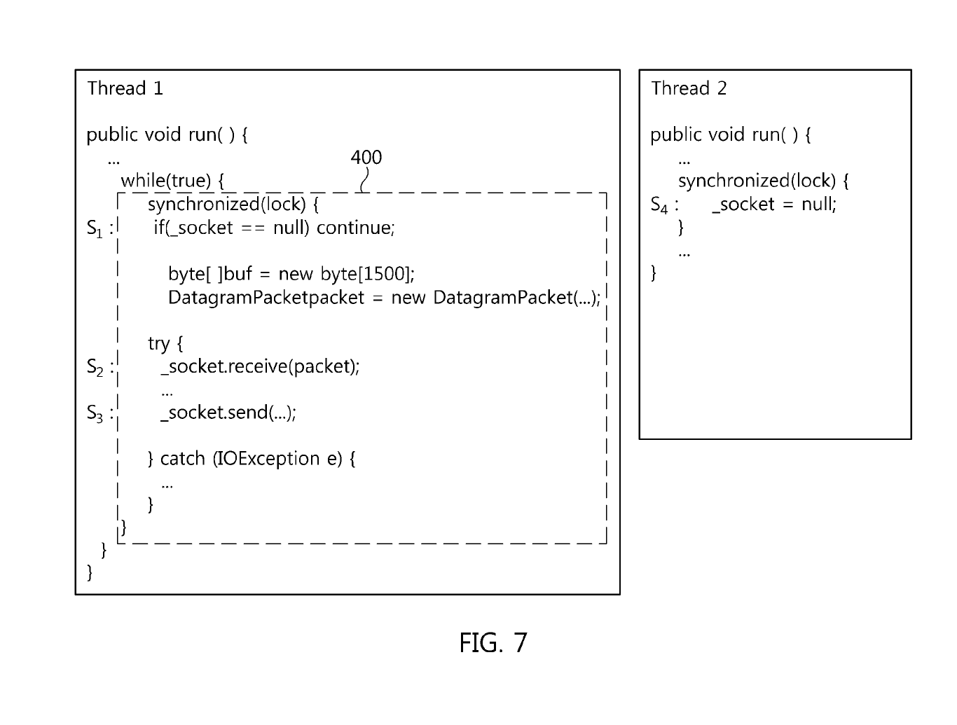

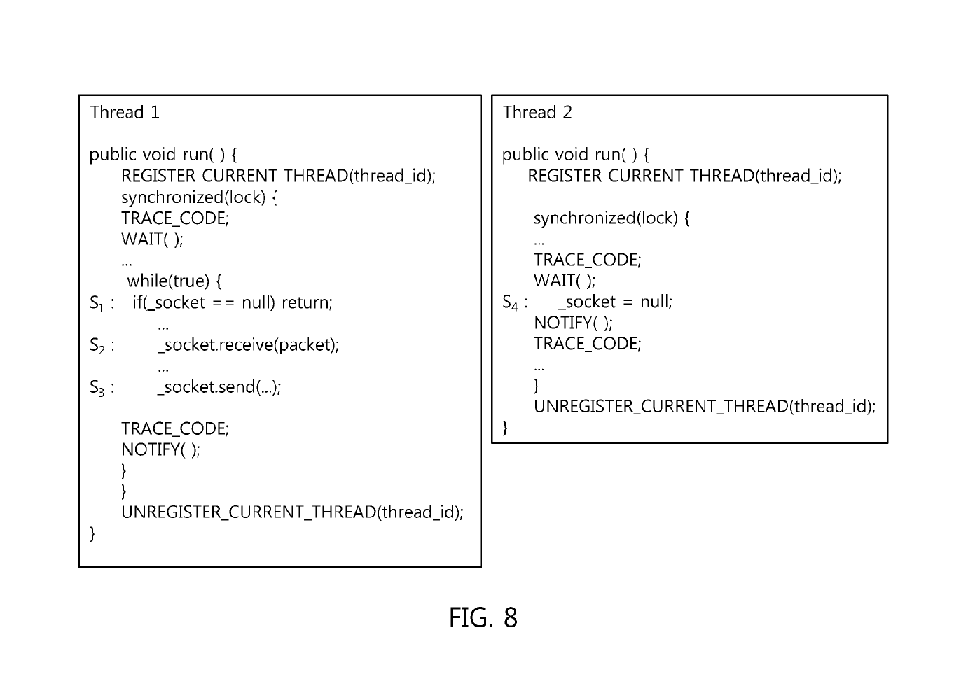

The information extracting module 210 extracts information from the input source code 100 (S100). Namely, the information extracting module 210 detects a shared variable and a shared thread class, a read statement and a write statement using a shared variable, a user added assert statement, a synchronized block. Hereinafter, a case in which the source code 100 including threads (i.e., Thread1 and Thread2) illustrated in FIG. 6 is input will be described as an example. Thread1 and Thread2 illustrated in FIG. 6 share _socket variable and simultaneously performed. In this case, after Thread1 checks that _socket variable is not null, an error occurs as Thread2 executes a code (S4 of Thread2) making _socket null immediately before accessing the corresponding variable. Such an error occurs due to interleaving between threads that cannot be easily predicable, and as the number of threads is increased and a code is complicated, it is difficult to perform detection and correction. In order to prevent occurrence of an error of interleaving, a synchronized function 400 (please refer to FIG. 7) may be called to a code of Thread 1 to prevent intrusion of execution of a different thread while Thread1 is being executed, thus preventing an error due to interleaving.

The trace code adding module 220 adds a trace code and a dynamic thread manager class to the source code 100 based on the information detected by the information extracting module 210 (S200). Namely, the trace code adding module 220 adds a trace code outputting log information before and after a read statement and write statement of the shared variable detected by the information extracting module 210 and before and after the synchronized block including the shared variable. The trace code adding module 220 adds a dynamic thread manager class managing information to a thread being operated in a program

In this case, the trace code adding module 220 inserts a code (i.e., REGISTER_CURRENT_THREAD method) of registering a thread ID to the dynamic thread manager class in the beginning of a run function of a thread. The trace code adding module 220 inserts a code (i.e., UNREGISTER_CURRENT_THREAD method) of removing a thread ID from the dynamic thread manager class in the end of the run function. For example, referring to FIG. 8, when a code (please refer to FIG. 6) of a thread is input, the trace code adding module 220 inserts a log information output code and a method of the dynamic thread manager class into a front stage and a rear stage of S1 to S4 to output to log information. Here, the log information output code is TRACE_CODE method, and the dynamic thread manager class includes WAIT method and NOTIFY method.

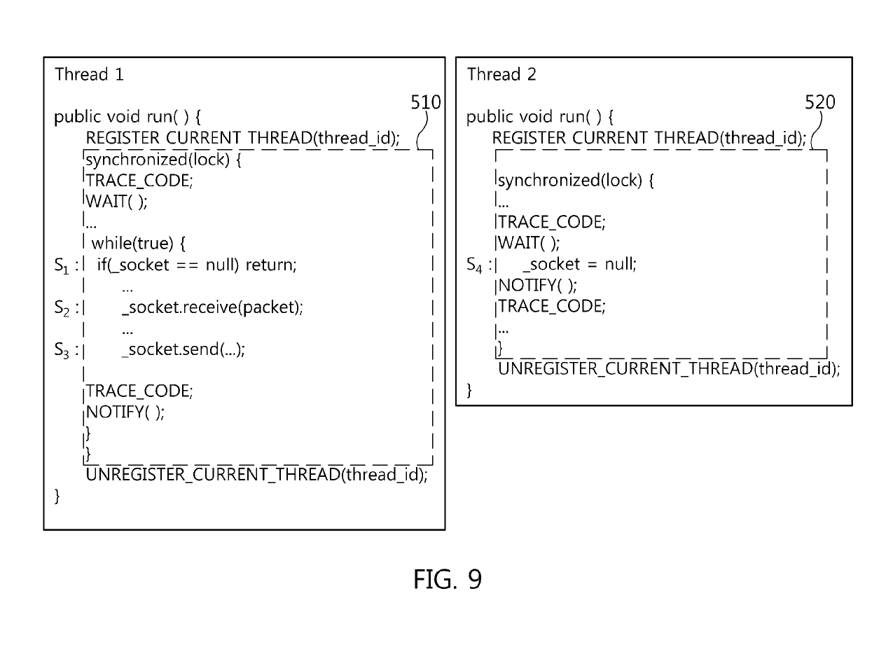

When information for program execution is input, the interleaving setting module 230 sets a thread included in the source code 100 as an interleaving block and executes the same (S300). In this case, the interleaving setting module 230 sets the thread as an interleaving block including the entirety of a single thread code (i.e., run function). When a thread using that uses a shared variable together with a current thread is being executed before executing of the interleaving block starts, the interleaving setting module 230 adds a code for making the corresponding thread wait, and when there is a thread that waits at the end of the interleaving block, the interleaving setting module 230 adds a code for allowing the corresponding thread to be re-executed. For example, when a code (please refer to FIG. 6) of a thread is input and S4 command statement is executed between S2 and S3, NullPointerException generated when S3 is executed. In order to find such a case, as illustrated in FIG. 9, the interleaving setting module 230 sets the entire run function of each of Thread1 and Thread2 as a single interleaving block. Namely, the interleaving setting module 230 sets the entire run function of Thread1 as an interleaving block 1-1 510 and sets the entire run function of Thread2 as an interleaving 2-1 520. The executing module 240 executes the set interleaving block 1-1 510 and the interleaving block 2-1 520.

When an error occurs in the executed interleaving blocks (S400; YES), the executing module 240 executes the interleaving block set by the interleaving setting module 230, and when an error occurs, the executing module 240 transmits log information output from a trace code added to the interleaving block to the interleaving setting module 230 and the trace information collecting module 250. Accordingly, the trace information collecting module 250 may store the log information and information of the interleaving block received from the executing module 240 as a file (S500).

The source code matching module 260 stores concurrency error information 300 including an error occurrence situation and position as a file based on the file generated by the trace information collecting module 250 (S600). Namely, the source code matching module 260 reads the file generated by the trace information collecting module 250 and stores the concurrency error information 300 including a line number of the source code 100 in which each error has occurred and an interleaving situation, as a file. Here, the line number of the source code 100 may be searched from the source code 100 by using a class name, a function name, and a variable name included in the log information.

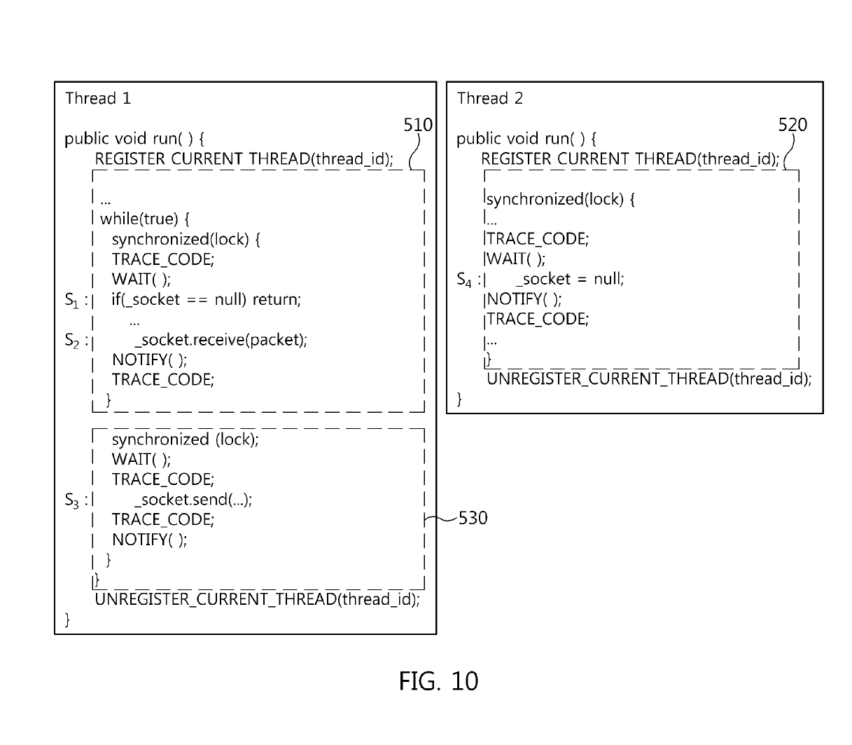

When an error does not occur in executing the interleaving block in operation S300, the interleaving setting module 230 splits the thread into a plurality of interleaving blocks and executes the same (S700). Namely, when the interleaving blocks (namely, the interleaving block 1-1 510 and the interleaving block 2-1 520) are normally executed by the executing module 240, as illustrated in FIG. 10, the interleaving setting module 230 sets S1-52, read statement of the shared variable in Thread1, as the interleaving block 1-1 510 and sets S3, write statement of the shared variable in Thread1, as the interleaving block 1-2 530. The interleaving setting module 230 sets the entire run function of Thread2 as the interleaving block 2-1 520. The executing module 240 executes the set interleaving block 1-1 510, an interleaving block 1-2, and the interleaving block 2-1 520.

When an error does not occur in executing the interleaving blocks (S800; NO), the interleaving setting module 230 determines whether the interleaving blocks are to be reset based on the sizes of the executed interleaving blocks. In this case, when the interleaving blocks do not have a minimum size (S900: NO), the interleaving setting module 230 performs the foregoing operations (S700 and S800) again. Namely, the process of splitting a thread code into several interleaving blocks and executing them in different orders is continuously performed until when each interleaving block includes a single shared variable read statement. In this case, splitting of interleaving blocks are performed on each thread by stages. In a first stage, the entirety of a thread is set to a single interleaving block. When there is no fault in performing the corresponding interleaving block, shared variable access statements are split to be distributed as a k part (k=2, 3, . . . , n) to each thread. This is repeated until when a single shared variable read statement is included in a single interleaving block. Here, as the threads are increased in number and codes accessing the shared variable are increased, the number of interleaving blocks are also increased, increase number of cases to be executed by the interleaving setting module 230. Thus, the interleaving setting module 230 may set to divide a size of an interleaving block only to a predetermined level to minimize an execution time of test, although accuracy is slightly lowered.

When an error occurs in executing the interleaving block in operation S800, operations S500 and S600 are performed to store the concurrency error information 300 as a file. Namely, when the executing module 240 executes the interleaving block 1-2 530 and the interleaving block 2-1 520, an error occurs. Thus, the concurrency error information 300 is stored as a file through the trace information collecting module 250 and the source code matching module 260.

As described above, according to the apparatus and method for detecting concurrency errors of a parallel program for a multicore, concurrency errors may be more accurately detected by directly controlling thread interleaving, rather than being executed in a computer itself.

Also, according to the apparatus and method for detecting concurrency errors of a parallel program for a multicore, since concurrency errors are detected by adjusting a size of interleaved thread command statement block by stages, accuracy and executed time of concurrency error detection may be adjusted.

While exemplary embodiments have been shown and described above, it will be apparent to those skilled in the art that modifications and variations could be made without departing from the spirit and scope of the present disclosure as defined by the appended claims.

What is claimed is:

1. An apparatus for detecting concurrency errors of a parallel program for a multicore, the apparatus comprising:
an information extracting module configured to detect interleaving information from an input source code;
a trace code adding module configured to add a trace code and a dynamic thread manager class to the source code based on the interleaving information detected by the information extracting module;
an interleaving setting module configured to split a thread included in the source code having the trace code and the dynamic thread manager class added thereto by the trace code adding module to set an interleaving block;
an executing module configured to execute the interleaving block set by the interleaving setting module;
a trace information collecting module configured to, when an error occurs in the interleaving block executed by the executing module, store log information output from the trace code added to the interleaving block and information of the interleaving information; and
a source code matching module configured to store error information based on the log information and the source code stored in the trace information collecting module.

2. The apparatus of claim 1, wherein the information extracting module detects interleaving information including a shared variable, a shared thread class, a shared variable read statement and write statement, a user added assert statement, and a synchronized block.

3. The apparatus of claim 1, wherein the trace code adding module adds the trace code before and after the shared variable read statement and write statement and before and after the synchronized block including a shared variable included in the interleaving information.

4. The apparatus of claim 1, wherein the trace code outputs log information including a time stamp, an ID of a thread being executed, a name of a class to which an executed code belongs, a name of a method to which an executed code belongs, an ID of a synchronized block, a name of an accessed variable, and a variable access mode.

5. The apparatus of claim 1, wherein the trace code adding module adds a dynamic thread manager class including a method of registering a set thread, a method of deleting set thread information, a method of stopping a set thread, a method of requesting resume of an operation of a thread other than a set thread, to the source code.

6. The apparatus of claim 5, wherein the trace code adding module adds a method of registering a thread set in the beginning of a run function of threads included in the source code and adds a method of deleting thread information set in the end of the run function.

7. The apparatus of claim 1, wherein the interleaving setting module sets an interleaving block having a maximum level including all of run functions of a thread, and splits the set interleaving block based on execution results of the set interleaving block having a maximum level to reset a plurality of interleaving blocks.

8. The apparatus of claim 7, wherein when an error does not occur in executing the set interleaving block, the interleaving setting module resets the interleaving block into a plurality of interleaving blocks having a level equal to or higher than a minimum level, and sets an interleaving block including a single shared variable read statement or user added assert statement as an interleaving block having the minimum level.

9. The apparatus of claim 1, wherein the interleaving setting module adds a code for changing a different thread using a shared variable of an interleaving block in the beginning of the interleaving block into a standby state, and adds a code for re-executing a thread changed to a standby state in the end of the interleaving block.

10. The apparatus of claim 1, wherein the source code matching module stores error information including an error occurrence situation and position.

11. A method for detecting concurrency errors of a parallel program for a multicore, the method comprising:
detecting, by an information extracting module, interleaving information from an input source code;
adding, by a trace code adding module, a trace code and a dynamic thread manager class to the source code based on interleaving information detected in the detecting operation;
splitting, by an interleaving setting module, a thread included in the source code having the trace code and the dynamic thread manager class added in the adding operation to set an interleaving block;
executing, by an executing module, the interleaving block set in the setting operation;
when an error occurs in the interleaving block executed in the executing operation, storing, by a trace information collecting module, log information output from the trace code added to the interleaving block and information of the interleaving block; and
storing, by a source code matching module, error information based on the log information stored in the operation of storing the log information and the information of the interleaving block.

12. The method of claim 11, wherein, in the operation of detecting the interleaving information, interleaving information including a shared variable, a shared thread class, a shared variable read statement and write statement, a user added assert statement, and a synchronized block are detected by the information extracting module.

13. The method of claim 11, wherein, in the operation of adding a trace code and a dynamic thread manager class, the trace code is added before and after the shared variable read statement and write statement and before and after the synchronized block including a shared variable included in the interleaving information by the trace code adding module.

14. The method of claim 11, wherein the trace code outputs log information including a time stamp, an ID of a thread being executed, a name of a class to which an executed code belongs, a name of a method to which an executed code belongs, an ID of a synchronized block, a name of an accessed variable, and a variable access mode.

15. The method of claim 11, wherein, in the operation of adding a trace code and a dynamic thread manager class, a dynamic thread manager class including a method of registering a set thread, a method of deleting set thread information, a method of stopping a set thread, a method of requesting resume of an operation of a thread other than a set thread, are added to the source code by the trace code adding module.

16. The method of claim 15, wherein, in the operation of adding a trace code and a dynamic thread manager class, a method of registering a thread set in the beginning of a run function of threads included in the source code is added and a method of deleting thread information set in the end of the run function is added by the trace code adding module.

17. The method of claim 11, wherein, in the operation of setting an interleaving block, an interleaving block having a maximum level including all of run functions of a thread is set and split based on execution results of the set interleaving block having a maximum level to reset a plurality of interleaving blocks by the interleaving setting module.

18. The method of claim 17, wherein, in the operation of setting an interleaving block, when an error does not occur in executing the set interleaving block, the interleaving block is reset into a plurality of interleaving blocks having a level equal to or higher than a minimum level, and an interleaving block including a single shared variable read statement or user added assert statement is set as an interleaving block having the minimum level by the interleaving setting module.

19. The method of claim 11, wherein, in the operation of setting an interleaving block, a code for changing a different thread using a shared variable of an interleaving block is added in the beginning of the interleaving block into a standby state, and a code for re-executing a thread changed to a standby state is added in the end of the interleaving block by the interleaving setting module.

20. The method of claim 11, wherein, in the operation of storing error information, error information including an error occurrence situation and position is stored by the source code matching module.
